(19) United States
(12) Patent Application Publication
(10) Pub. No.: US 2005/0068761 A1
(43) Pub. Date: Mar. 31, 2005

(54) Optical effects device for a super thin lighting element

(76) Inventor: Tseng-Lu Chien, Taipei Hseng (TW)

Correspondence Address: BACON & THOMAS, PLLC, 625 SLATERS LANE, FOURTH FLOOR, ALEXANDRIA, VA, 22314, US

(21) Appl. No.: 10/669,563

(22) Filed: Sep. 25, 2003

(51) Int. Cl. F21V 9/16

(52) U.S. Cl. 362/84; 362/189

(57) ABSTRACT

An optical effects device for enhancing the lighting effect of a super thin lighting element is of a transparent material in the form of a sheet, gel, cylinder, tube, or other geometric shape to which the super thin lighting element is attached. The material of the optical effect device may be polyvinyl chloride (PVC), acrylic, polycarbonate, polyethylene, ABS plastic, silicone, epoxy, rubber, or any other easily worked material having sufficient transparency to permit passage of light from the light emitting element through the material, and provides a barrier to UV radiation and humidity. By appropriately shaping the optical device, the light from the lighting element can be magnified in order to increase the effective size of the element, or to change the viewing angle. Also, by silk-screening the optical material, or by stenciling it or masking it with a suitable opaque or translucent film or sticker, whether on an outside or interior surface, a variety of light patterns can be obtained which, in combination with the optical effects, can greatly increase the design versatility of the lighting elements. In addition, different electro-luminescent and photo-luminescent materials can be combined within the optical device to provide a number of different lighting effects, and the optical effects device can be arranged to be attached to a variety of main objects, or to enclose a variety of main objects.

### BACKGROUND OF THE INVENTION

1. Field of the Invention

This invention relates to an optical effect device for improving the lighting performance of a super thin lighting element. By “super thin” lighting element is meant a lighting element of the type containing a light emitting chemical sandwiched between protective layers or sheets, and which typically has a thickness of less than ten millimeters. The light emitting chemical may be an electro-luminescent material, a photo-luminescent material, or a combination of both.

2. Discussion of Related Art

Super thin lighting elements of the type described above offer a number of advantages over conventional lighting elements such as incandescent light bulbs and light emitting diodes. These advantages include flexibility, which allows the lighting elements to follow curves on the main object to which they are attached, the ability to be printed or silk-screened with logos, marks, figures, and characters, or to be stenciled or masked, the availability of a wide variety of color choices, including green, blue, pink, yellow, and white, and low assembly and design costs. Nevertheless, currently available super thin lighting elements also have several disadvantages, including high materials costs, installation problems in certain applications, safety concerns with respect to high voltages in the case of electro-luminescent elements, and sensitivity to ultra-violet (UV) light and humidity.

The high materials costs result both from the cost of the luminescent materials used in the lighting elements, and in the cost of equipment for laminating the materials to protective sheets. As a result, electro-luminescent or photo-luminescent lighting elements are usually sold by area (cm² or in²) and thus the cost of the lighting element increases in proportion to the area to be covered. For many applications, this cost can be prohibitive.

Although super thin lighting elements are in general easily assembled or affixed to main objects of various types, a problem arises in that the easier it is to assemble a lighting element to a hard or soft surface, the easier it is to disassemble or damage it. As a result, even though super thin lighting elements in principle have the advantage of simple assembly, installation is often complicated in practice by the need to protect the lighting element from damage.

The problem of damage is especially critical in the case of electro-luminescent strips because electro-luminescent strips generally require high alternating current voltages to activate, and thus the two terminals of each strip are usually at or above 110 VAC, presenting a significant shock hazard when the terminals become accidentally exposed. This is of particular concern since electro-luminescent lighting is used in a variety of applications intended for children, including clothing, toys, and sports equipment.

The final problem has to do with the vulnerability of both electro-luminescent and photo-luminescent lighting to is the UV components of sunlight and to moisture in the environment. Both of these hazards will significantly shorten the useful life of the lighting elements.

### SUMMARY OF THE INVENTION

It is accordingly an objective the invention to provide a device for increasing the effective area of a super thin lighting element such as an electro-luminescent or photo-luminescent strip or panel without proportionally increasing its cost.

It is another objective of the invention to provide a device for protecting a super thin lighting element such as an electro-luminescent or photo-luminescent strip or panel from damage or disassembly.

It is yet another objective of the invention to provide a device for sealing a super thin lighting element such as an electro-luminescent strip or panel so as to prevent access to the high voltage terminals and reduce the risk of electric shock.

Finally, it is also an objective of the invention to provide a device of protecting a super thin lighting element such as an electro-luminescent or photo-luminescent strip or panel from environmental hazards such as UV radiation and humidity.

These objectives are achieved, in a preferred embodiment of the invention, through the use of an optical effect device made, for example, of a transparent chemical or material in the form of a sheet, gel, cylinder, tube, or other geometric shape, and which may be solid or in the form of a transparent material filled with another transparent material, and to which the electro-luminescent or photo-luminescent element is attached, or into which the electro-luminescent or photo-luminescent material is inserted.

Those skilled in the art will appreciate that the electro-luminescent and/or photo-luminescent materials may be attached to the optical effects material in a variety of different ways, depending on the materials involved (for example, if the optical effect material is silicone, a primer is required before an adhesive can be applied). Similarly, a variety of means for affixing the optical effects device to a main object may be provided, including press-fitting, stitching, glue, heat or ultra-sonic welding, riveting, use of a solvent, and so forth, or the optical effects may be arranged to completely surround the main object.

Optionally, the optical effects device may include a lightweight filler material such as polyurethane foam, polyform, or the same material as the optical material, for the purpose of further increasing protection from humidity and extreme temperatures, to surround and protect the high voltage terminals of an electro-luminescent strip from exposure, and to surround and protect electric components within the device from damage.

Finally, those skilled in the art will appreciate that the super thin lighting element with optical effects device may used in a variety of applications for increasing the visibility of the lighting element in a dark environment, including a variety of applications in which the optical effects device is attached to the maim object and the range of main objects includes, by way of example, shoes and other footwear, skates, skateboards and other rolling or sliding objects, backpacks, helmets, caps, vests, belts, protective pads, flying objects such as flying discs, vehicles, and other main objects suitable for outdoor use, as well as a variety of applications in which the transparent optical member surrounds the main body to which it is attached, examples of which include clocks, thermometers, gearshift knobs, telephones, and lighted handle grips.

### BRIEF DESCRIPTION OF THE DRAWINGS

FIG. 1 is a perspective view illustrating an application of the optical effects device of a first preferred embodiment of the invention.

FIG. 1-1 is a more detailed perspective view of a preferred optical effects device similar to the one shown in FIG. 1.

FIG. 1-2 is a perspective view of a variation of the preferred optical effects device shown in FIG. 1-1.

FIG. 1-3 shows different designs which can be used in connection with the preferred optical effects devices shown in FIGS. 1, 1-1, and 1-2.

FIG. 2 is an exploded perspective view of a version of the preferred optical effects device illustrated in FIG. 1-1.

FIG. 3 is a perspective view showing the manner in which the preferred optical effects device and a lighting element are assembled together.

FIG. 3-1 is a cross-sectional side view of the lighting element and optical effects device shown in FIG. 3.

FIGS. 3-2 to 3-5 are cross-sectional side views of variations of the lighting element and optical effects device of FIGS. 3 and 3-1, in which the shape and hence the optical properties of the optical effects device are modified.

FIGS. 4-1 to 4-3 are perspective views of different installations of the preferred optical effects device on a main object.

FIGS. 5 and 5-1 are perspective views showing further examples of installations for the preferred optical effects device.

FIGS. 6 and 6-1 are perspective views showing still further examples of installations for the preferred optical effects device.

FIG. 7 is a block diagram of electrical circuitry for and electro-luminescent strip or panel which can be used in connection with the lighting element with optical effects device of the preferred embodiment of the invention.

FIG. 8 is a schematic circuit diagram corresponding to the block diagram of FIG. 7.

FIG. 9 is a perspective view of an alternative preferred embodiment of the invention in which the object to which the light means is to be attached is inside the transparent optical device.

FIG. 10 is a perspective view of an implementation of the embodiment shown in FIG. 9, in which the main object is a clock.

FIG. 11 is a perspective view of an implementation of the embodiment shown in FIG. 9, in which the main object is a gearshift head.

FIG. 12 is a perspective view of an implementation of the embodiment shown in FIG. 9, in which the main object is a telephone.

FIG. 13 is a perspective view of an implementation of the embodiment shown in FIG. 9, in which the object is a lighted grip.

FIG. 14 is a perspective view of a variation of the embodiment shown in FIG. 1-1.

FIG. 15 is a perspective view showing an embodiment which combines the principles of the embodiments of FIGS. 9 and 1-1, and further includes two main objects.

FIG. 16 is a perspective view showing a variation of the embodiment of FIGS. 1-8, in which the main object is a shoe.

FIG. 17 is a perspective view showing a variation of the embodiment of FIGS. 1-8, in which the main object is a roller skate.

### DETAILED DESCRIPTION OF THE PREFERRED EMBODIMENTS

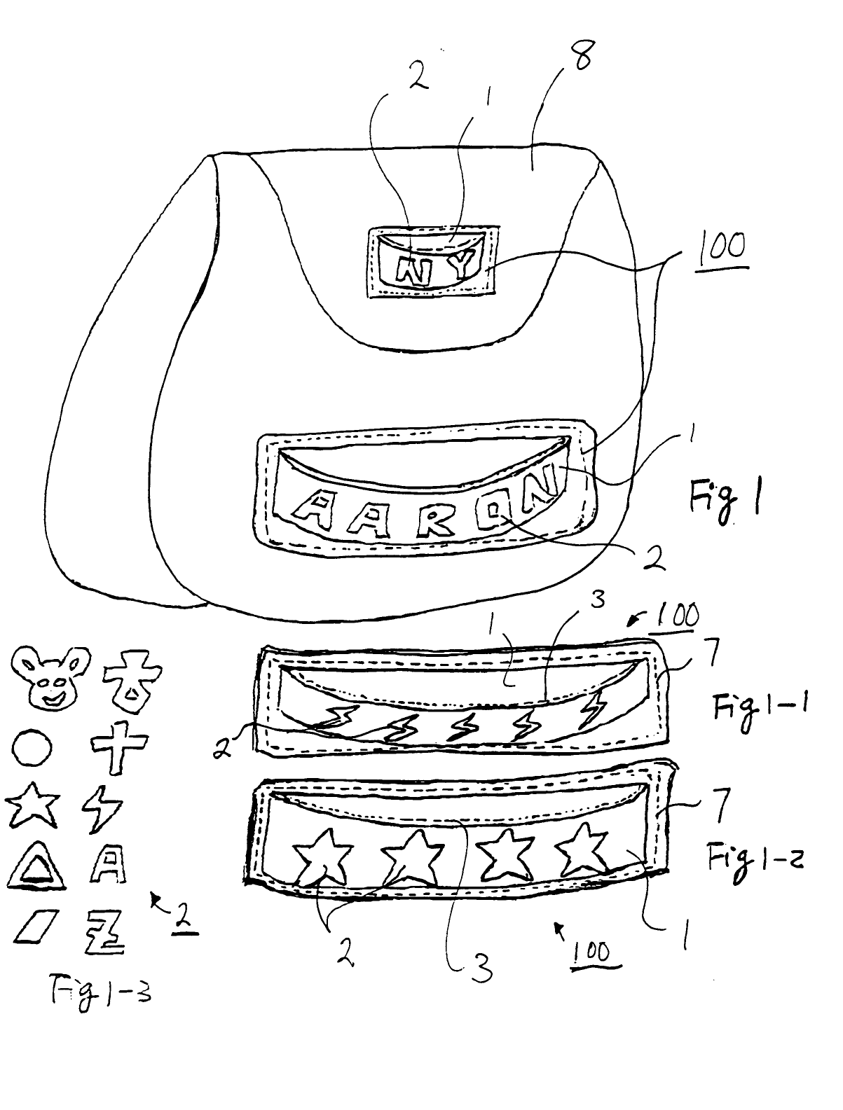

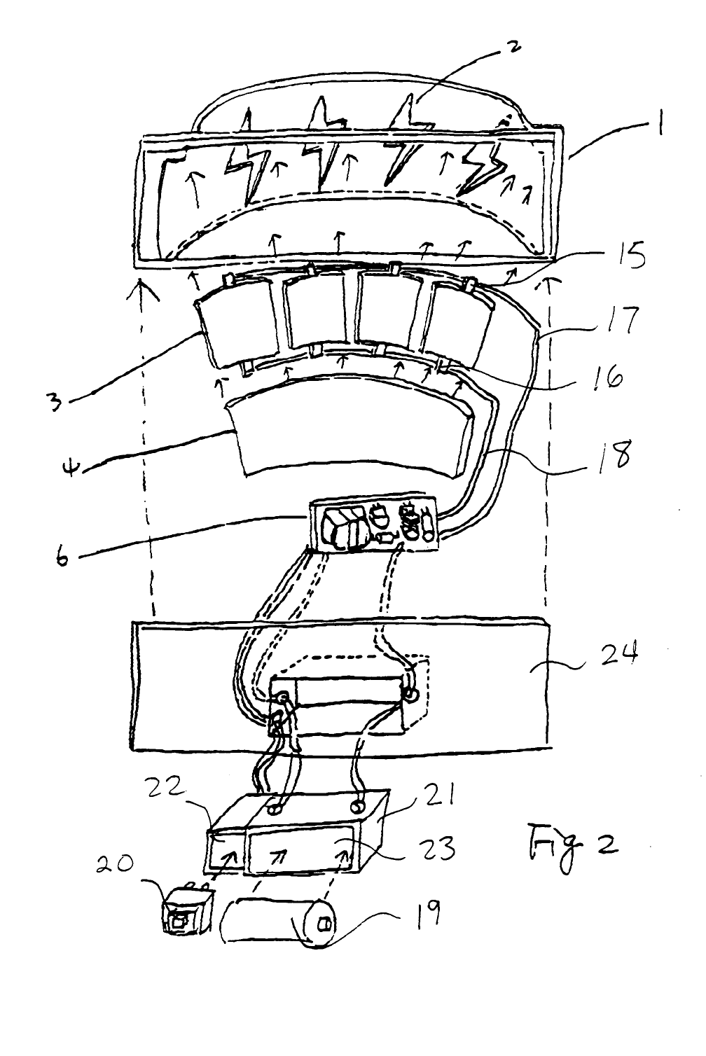

FIG. 1 illustrates an application of the optical effects device of the invention in which a pair of optical effects devices 100 are applied to a main object 8 in the form of a backpack. Advantageously, each of the devices includes a transparent optical device or member 1 made of a transparent material of the type described above, and decorative markings 2 which may be in the form of silkscreen printing, stenciling, masking by an opaque or semi-transparent film, or the like. Those skilled in the art will appreciate that the main object 8 to which the devices are applied may be any object for which illumination is desired, including by way of example shoes and other footwear, skates, skateboards and other rolling or sliding objects, helmets, caps, vests, belts, protective pads, flying objects such as flying discs, vehicles, and so forth. In addition, those skilled in the art will appreciate that the designs 2 on the objects can take a variety of forms other than the lettering of FIG. 1, including lightning bolts as shown in FIG. 1-1, stars as shown in FIG. 1-2, and a variety of other designs as shown in FIG. 1-3. The designs shown in FIG. 1-3 are of course not meant to be limiting, but merely illustrative of a few of the unlimited variety of designs which are possible. Finally, it is noted that to emphasize the common features of the invention, all “main objects” are represented, regardless of form, by reference numeral 8, all versions of the transparent optical member, regardless of shape, by reference numeral 1, all markings, regardless of the design, by reference numeral 2, and so forth.

The material of the optical effect device may be polyvinyl chloride (PVC), acrylic, polycarbonate, polyethylene, ABS plastic, silicone, epoxy, rubber, or any other easily worked material which can be made sufficiently transparent to permit passage of light from the light emitting element through the material, and provides a barrier to UV radiation and humidity. By appropriately shaping the optical device, the light from the lighting element can be magnified in order to increase the effective size of the element, or to change the viewing angle. Also, by silk-screening the optical material, or by stenciling it or masking it with a suitable opaque or translucent film or sticker, whether on an outside or interior surface, a variety of light patterns can be obtained which, in combination with the optical effects, can greatly increase the design versatility of the lighting elements, as well as increasing the attractiveness of the device when not lighted. In addition, different electro-luminescent and photo-luminescent materials can be combined within the optical device to provide a number of different lighting effects.

As shown in FIGS. 1-1 and 1-2, each optical effects device 100 includes, in addition to the transparent optical member 1 and markings 2, a “fixing means” 7, illustrated in the Figures as a lip arranged to be stitched, welded, glued or otherwise adhered to the main object, and a lighting element 3, shown in dashed line in these Figures. The use of a lip is of course optional, depending on the shape of the main object to which the optical effects device is to be attached, as is the shape and number of lighting elements included in the device.

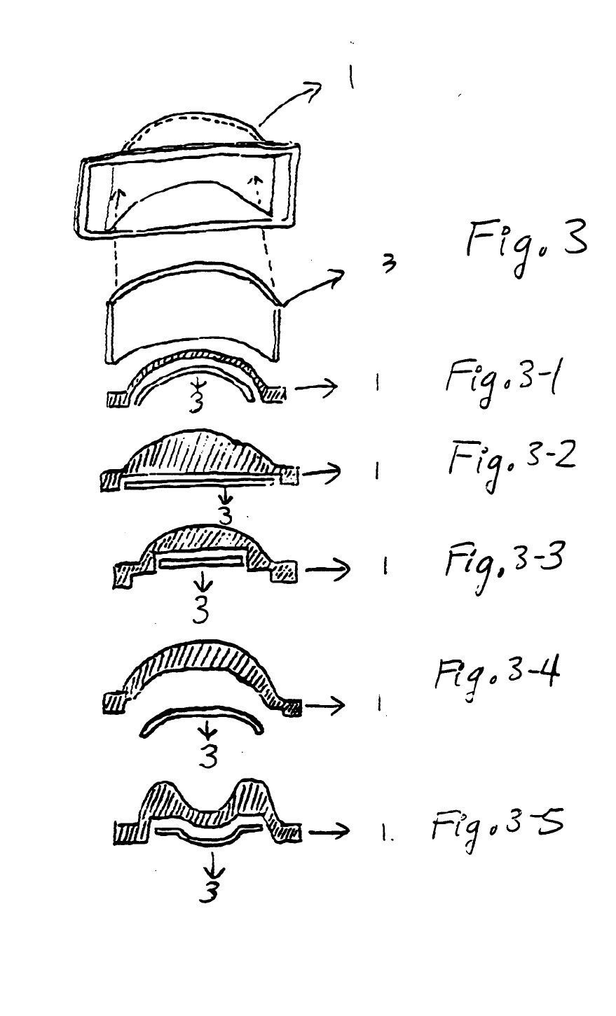

As illustrated in FIGS. 2 and 3, the optical effects device according to a preferred embodiment of the invention includes transparent optical member 1 having a geometric shape which permits passage of light in different directions, and markings or design elements 2 in the form of lightning bolts cut from an opaque or translucent film applied to the front of the transparent optical member. Optical member 1 is open at its rear to permit insertion into the member of a plurality of super-thin lighting elements 3 illustrated as including terminals 15 and 16 connected in parallel by wires 17 and 18 to circuitry on a circuit board 6, circuit board 6 in turn being connected to terminals of a battery 19. Both the circuit board 6 and battery 19, as well as a manual on/off switch 20, are illustrated as being situated in a housing 21 having respective compartments 22 and 23 for the switch and battery, the housing being mounted on a rear cover 24 of the transparent optical member 1, although those skilled in the art will appreciate that the circuit board 6, battery 19, and switch 20 could alternatively be positioned anywhere on the main object to which the lighting effects device is attached. The battery compartment 23 and switch 20 are preferably accessible through cover 24 to permit activation of the switch and replacement of the battery. Finally, member 4 is an adhesive member used to affix the lighting elements to the transparent optical member, and may take any form which accomplishes the objective of securing the lighting elements at desired positions within the transparent optical member.

As illustrated in FIGS. 3-1 to 3-5, the cross-sectional shape of the transparent optical device may take a variety of forms depending on the nature of the optical effect desired. For example, the even thickness design illustrated in FIGS. 3-1 and 3-4 will transmit the light from the curved lighting element 3 over an angle of 180°, the difference between the two Figures being the thickness of the material depicted. On the other hand, the designs shown in FIGS. 3-2 and 3-3 are arranged to magnify light from the flat lighting element 3, while FIG. 3-5 illustrates a wave-shaped optical element.

As shown in FIGS. 4-1 to 4-3, the main object 8 may have a plurality of differently shaped optical effects devices attached thereto. These Figures also illustrate the principle that the optical effects device may be attached to an interior surface of the main object and arranged to extend or be visible through a cut-out or cutouts 81 in the main object 8. Similarly, FIG. 5 shows a design in which the transparent optical device is a gel-like member attached to the front of a relatively thick main object, with the lighting element inserted from the rear into an opening in the main object, and FIG. 5-1 shows a variation in which the main object has varying thickness.

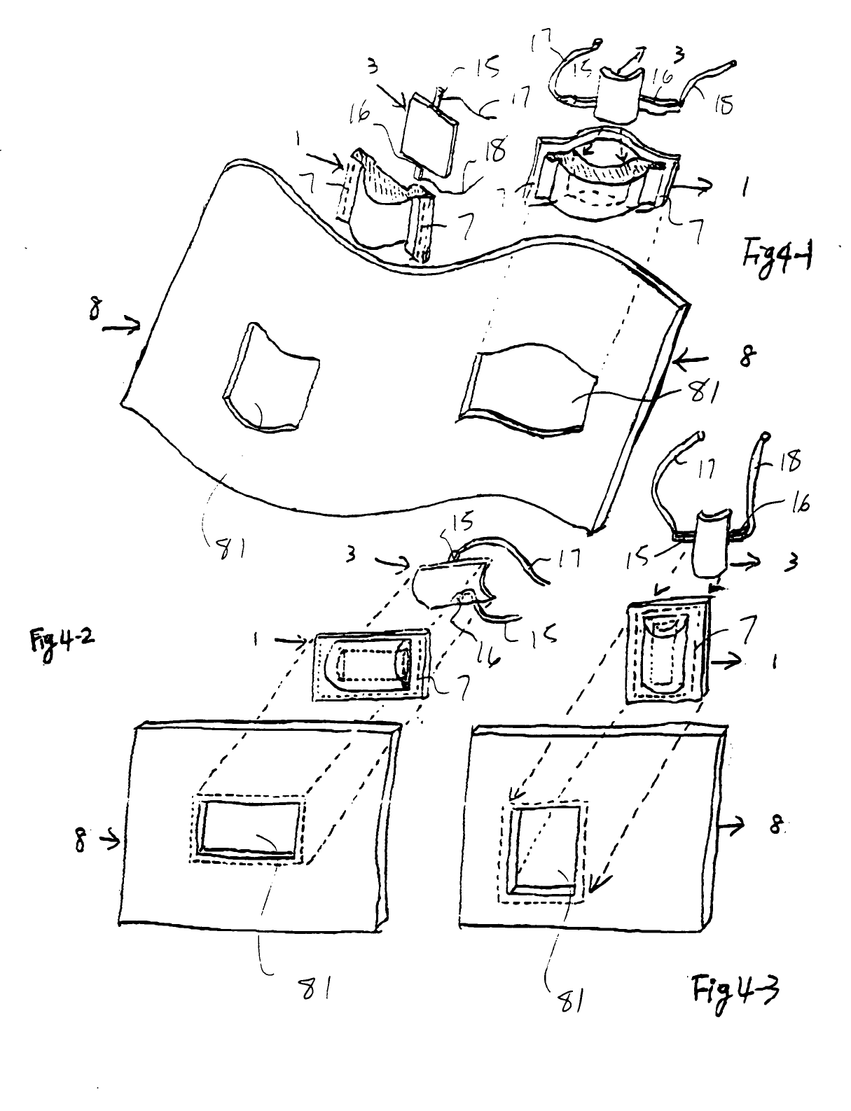

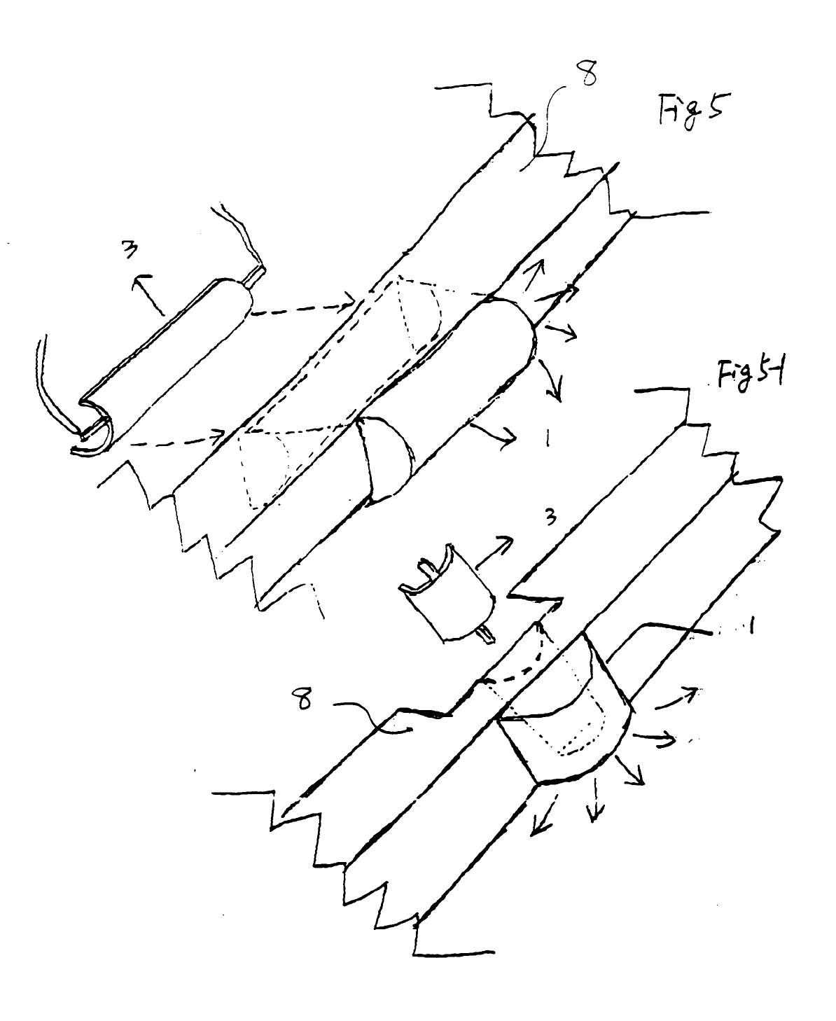

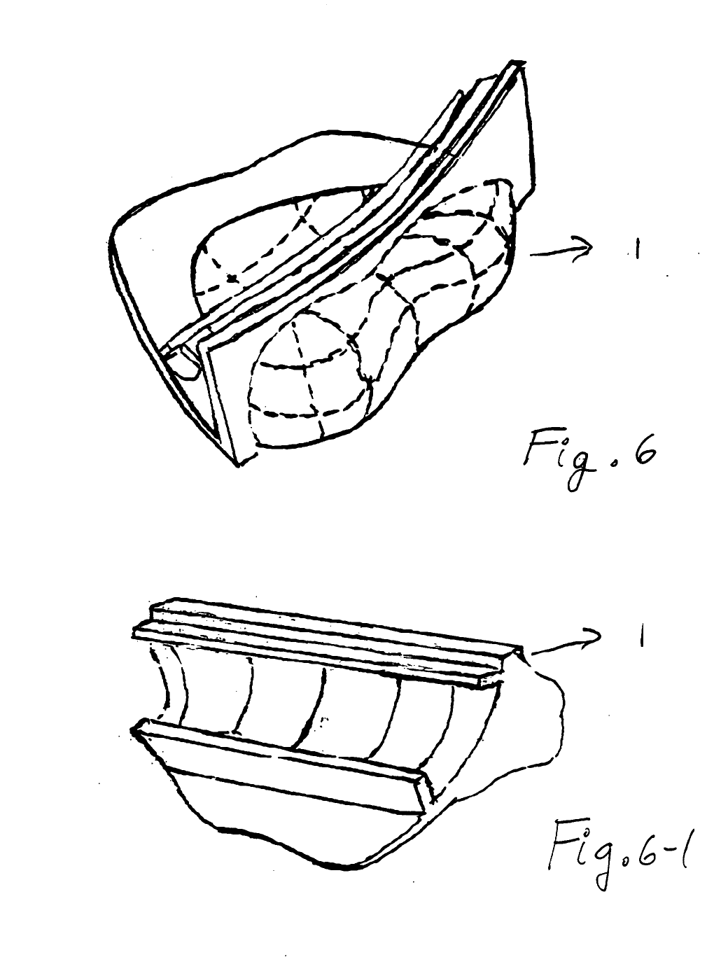

FIGS. 6 and 6-1 show further variations of the first preferred embodiment of the invention in which the transparent optical device has a complex curvature for even more spectacular optical effects.

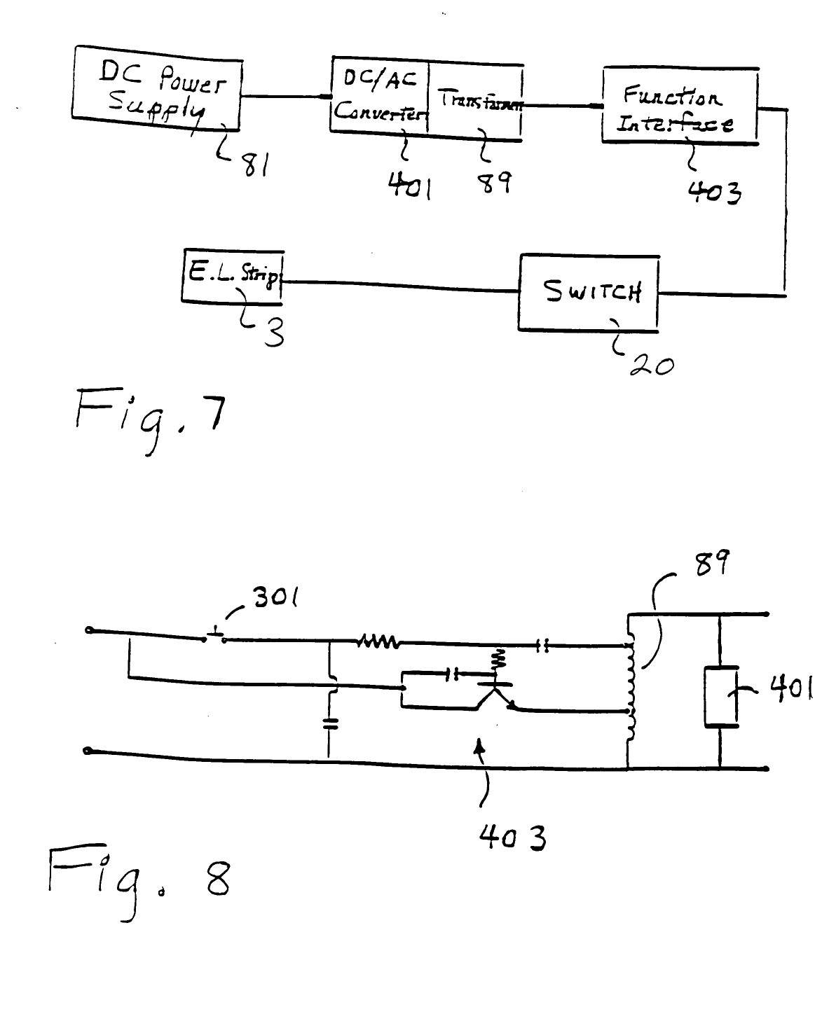

Turning now to the circuitry shown in FIGS. 7 and 8, which those skilled in the art will appreciate would only be used in the case of an electro-luminescent or other electrical powered lighting element, there being no need to include such circuitry if the lighting element is a photo-luminescent strip, a DC power supply 31 is electrically connected to the lighting element 3 via circuitry which includes a DC/AC converter 401 electrically connected with a transformer 402, transformer 402 being further electrically connected with a function interface 403 and, via parallel connected switch 4, to the lighting element 3. Those skilled in the art will appreciate that the battery 19 in this embodiment of the invention can be a rechargeable battery which can be charged by a device having a higher voltage output than the battery's, and that the direct current supplied by DC power source 31 is thus converted into an alternating current of a desired frequency by DC/AC converter 401 and supplied to the transformer 402 for increasing the voltage of the alternating current, and then transmitted from the transformer 402 to the function interface 403. Function interface 403 provides a number of preset or switchable options for turning on the lighting element 2, e.g., steady, flash, sequential or random, and may take any desired form from a simple circuit as illustrated in FIG. 10 to a microprocessor, depending on the complexity of the special effects to be exhibited. Those skilled in the art will appreciate that the number of options is greatly increased if a multiple element strip such as the one disclosed in copending U.S. patent application Ser. No. 08/305,294 is utilized.

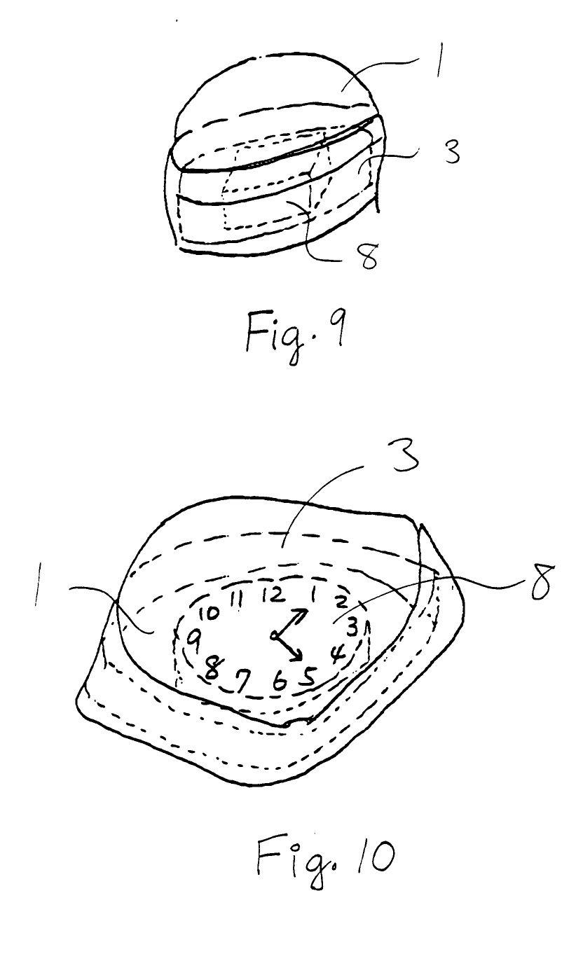

In the embodiment and its variations shown in FIGS. 1-6, the optical effects device was placed on the outside of the main object with which it is associated. In a variation of this concept, a second preferred embodiment of the invention involves placing the object within the transparent optical device, as generically illustrated in FIG. 9. In that case, the lighting element not only may be directly visible from outside the transparent optical member, but also can face inwardly to illuminate the object within the transparent optical member. In each of the implementations illustrated herein of this second preferred embodiment of the invention, the lighting element 3 surrounds the main object 8, although those skilled in the art will appreciate that numerous different combinations of the lighting element and the main object within the transparent optical device are possible. The implementations illustrated in FIGS. 10-13 are respectively an LCD clock, a gearshift knob, a telephone, a lighted grip such as might be used to provide a handhold in poorly lighted stairwells.

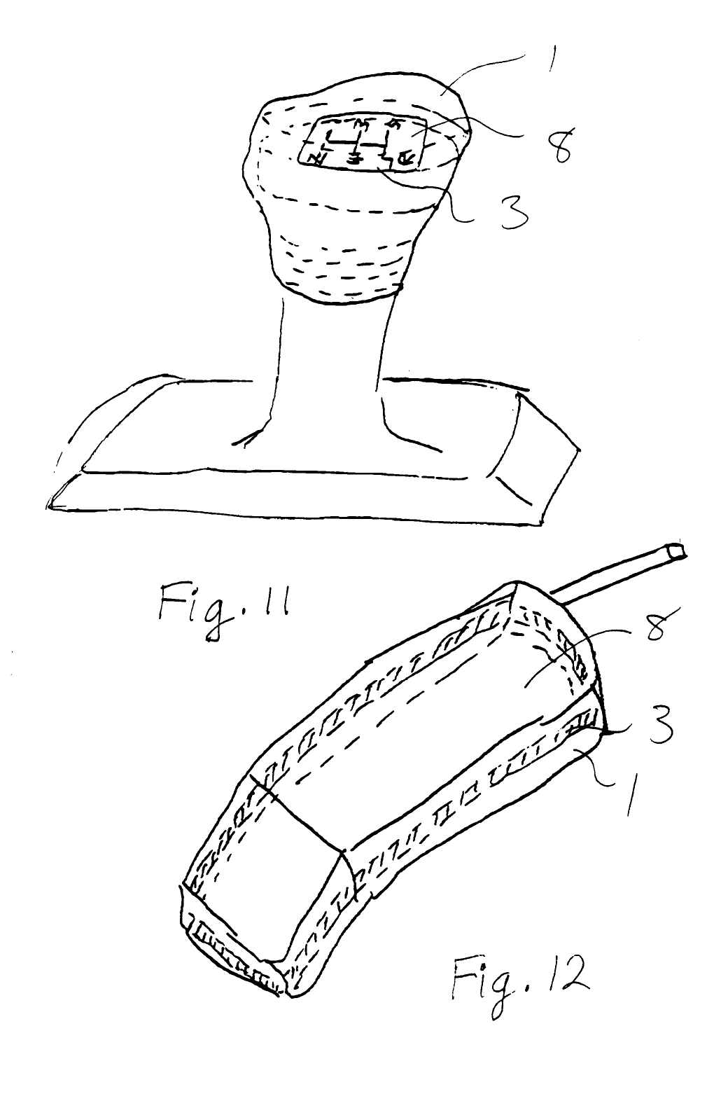

The optical effects device shown in FIG. 14 is similar to that shown in FIGS. 1-6 but has a shape which is particularly suitable, according to a variation of the embodiment shown in FIGS. 9-13, for the inclusion of two main objects 8 within the transparent optical member, such as LCD clock and thermometer.

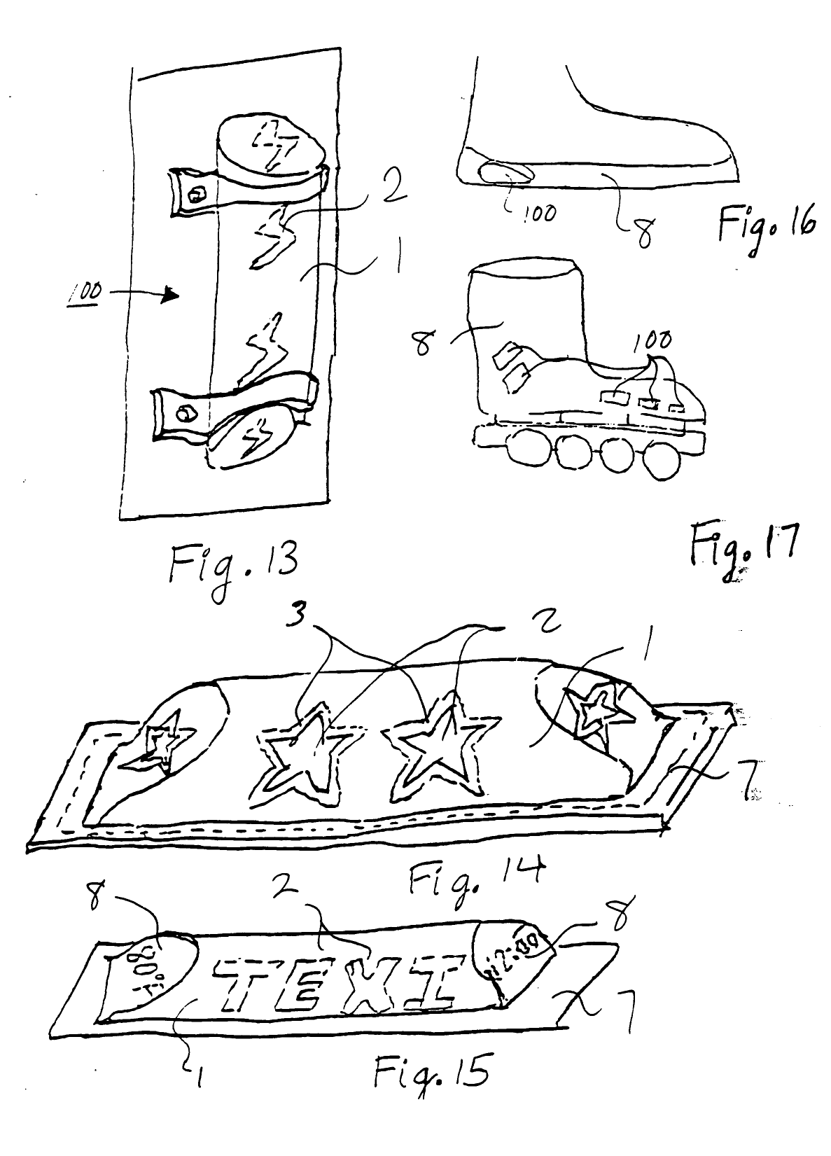

Finally, FIGS. 16 and 17 show further examples of the first preferred embodiment of the optical effects device of the invention. These Figures show how the optical effects device may be used as a substitute for unprotected lighting elements in a variety of super thin lighting device applications, including a shoe and a roller skate. In these applications, in particular, the magnifying effect of the preferred optical effects device is especially advantageous because of the limited space available for the lighting elements. Several such applications are disclosed in copending applications of the Inventor, including U.S. patent application Ser. Nos. 08/409,925, and 08/432,707, and many of the features disclosed in these applications would be suitable for use with the present invention, including the manner in which the circuitry for powering the lighting elements is placed on the main object and shared by several lighting elements. Similar sharing of circuitry and arrangement of the power pack on the main object can be used with the optical effects devices of the present invention.

Having thus described several preferred embodiments of the invention and a number of variations and modifications of the preferred embodiments, it is anticipated that still further variations and modifications will undoubtedly occur to those skilled in the art upon reading the above description. It is therefore intended that the invention not be limited by the above description, but rather that it be interpreted, in accordance with the appended claims, to cover all such variations and modifications which fairly fall within the scope of the invention.

1. An optical effects device, comprising:
a transparent optical member having a shape which determines optical properties of the transparent member;
a super thin lighting element;
means for attaching the super thin lighting element to the transparent member;
means for fixing the transparent optical member relative to a main object.

2. A device as claimed in claim 1, wherein the super thin lighting element is an electroluminescent lighting element, and further comprising electrical circuitry for supplying a trigger signal to the lighting element.

3. A device as claimed in claim 1, wherein the lighting element is a photoluminescent element.

4. A device as claimed in claim 1, further comprising a stuffing material which encloses and protects the lighting element, said stuffing material being selected from the group consisting of a foam material and a same material as a material of the transparent optical member.

5. A device as claimed in claim 4, wherein the lighting element is an electro-luminescent element, and wherein control circuitry for the lighting element is placed inside said stuffing, with access to a battery and switch.

6. A device as claimed in claim 1, wherein the transparent optical member is made of a material selected from the group consisting of polyvinyl chloride, ABS, polyethylene, polypropylene, silicone, rubber, epoxy, PC, and wherein said member includes at least one transparent area.

7. A device as claimed in claim 1, wherein said optical properties are a function of different thicknesses of the transparent member.

8. A device as claimed in claim 1, wherein said design means is a pattern selected from the group consisting of a silk-screened pattern, a stencil, a cover film, and arrangement of particles in the lighting element in order to enhance the attractiveness of the lighting arrangement both in darkness and light.

9. A device as claimed in claim 1, wherein the lighting element includes both electro-luminescent and photo-luminescent elements to provide back-up lighting in case power to the electro-luminescent lighting fails.

10. A device as claimed in claim 1, wherein the fixing means comprises means for fixing the transparent optical device securely to a surface of the main object.

11. A device as claimed in claim 1, wherein the lighting element is affixed to an inside surface of the transparent optical member, and wherein the transparent optical member is in the form of a sheet, cylinder, tubing, or other shape.

12. A device as claimed in claim 1, wherein the lighting elements consist of different diameter particles between sheets.

13. A device as claimed in claim 1, wherein the fixing means is selected from the group consisting of glue, Velcro™, stitching, screws, heat welding, ultra-sonic welding, and melting by a solvent.

14. A device as claimed in claim 1, further comprising additional lighting elements facing in a plurality of different directions.

15. A device as claimed in claim 1, wherein the main object is situated within the transparent optical member.

16. A device as claimed in claim 15, wherein the main object is selected from the group consisting of a clock, a gearshift handle, a telephone, a thermometer, and a combined clock and thermometer.

17. A device as claimed in claim 16, wherein the lighting element serves as a backlight for the whole main object.

18. A device as claimed in claim 1, wherein the lighting element is an electro-luminescent lighting element and the optical effects device includes a self-contained housing for a battery, switch, and circuitry for triggering the electro-luminescent element.

19. A device as claimed in claim 18, wherein the circuitry is enclosed and access is available only to the switch and battery so as to protect the user from shock hazard.

20. A device as claimed in claim 1, wherein said optical effects device encloses a plurality of main objects.

21. A device as claimed in claim 1, wherein said main object has attached thereto a plurality of said optical effects devices, and wherein said optical effects devices share a single control circuit positioned on the main object.

22. A device as claimed in claim 1, wherein said lighting element includes an electro-luminescent element, and a power pack for said electro-luminescent element is positioned on the main object outside of the optical effects device.
